(19) United States
(12) Patent Application Publication
(10) Pub. No.: US 2026/0214474 A1
(43) Pub. Date: Jul. 23, 2026

(54) LIFE CYCLE MANAGEMENT FOR SENSING

(71) Applicant: Huawei Technologies Co., Ltd., Shenzhen (CN)

(72) Inventors: Hao Tang, Ottawa (CA); Jianglei Ma, Ottawa (CA); Peiying Zhu, Ottawa (CA); Wen Tong, Ottawa (CA)

(21) Appl. No.: 19/571,372

(22) Filed: Mar. 18, 2026

Related U.S. Application Data
(63) Continuation of application No. PCT/CN2024/078988, filed on Feb. 28, 2024.
(60) Provisional application No. 63/583,917, filed on Sep. 20, 2023.

(51) Int. Cl. H04W 24/02; H04L 67/12; H04W 84/18

(52) U.S. Cl. CPC H04W 24/02; H04L 67/12; H04W 84/18

(57) ABSTRACT

Example embodiments of the present disclosure relate to a life cycle management for sensing. An example method includes: receiving, by a terminal device, a configuration of a sensing type or at least one sensing functionality for a sensing feature; and performing a sensing or communication operation based on the configuration of the sensing type or the at least one sensing functionality. In this way, an air interface procedure for implementing a sensing functional framework is designed.

### CROSS-REFERENCE TO RELATED APPLICATIONS

This application is continuation of International Application No. PCT/CN2024/078988, filed on Feb. 28, 2024, which claims the benefit and priority to U.S. Provisional Patent Application No. 63/583,917 filed Sep. 20, 2023. All of the aforementioned applications are incorporated herein by reference in their entireties.

### FIELD

Example embodiments of the present disclosure generally relate to the field of communications, and in particular, to a life cycle management for sensing.

### BACKGROUND

Sensing is a process of obtaining surrounding information. A radio frequency (RF) sensing is a process of sending a RF signal and obtaining the surrounding information either by receiving and processing of this RF signal or the echoed (reflected) RF signal. For example, sensing can be used to detect the information of an object, such as location, speed, distance, orientation, shape, texture etc. An integrated sensing and communication (ISAC) system is a system which reuses the communication RF signal for sensing. The ISAC system is a networked and cooperative sensing system instead of a single standalone radar system. Cooperating sensing can be done via the integrated communication protocols. In addition to performing a sensing operation to obtain information about an object, communication can be aided based on received sensing results (e.g., a sensing model, which is a modeling of the surrounding environment). Studies on designs of the sensing functional framework and corresponding air interface procedure are needed.

### SUMMARY

Some embodiments of the disclosure will propose a solution for the sensing functional framework. In particular, some embodiments of the disclosure will propose a solution for a life cycle management for sensing in the sensing functional framework and corresponding air interface procedure.

In a first aspect, there is provided a method. The method comprises: receiving, by a terminal device, a configuration of a sensing type or at least one sensing functionality for a sensing feature; and performing a sensing or communication operation based on the configuration of the sensing type or the at least one sensing functionality. In this way, an air interface procedure for implementing a sensing functional framework is designed.

In some example embodiments, the method further comprises: transmitting an indication of the sensing feature and an indication of one or more sensing functionalities associated with the sensing feature, wherein the sensing feature and the one or more functionalities are supported by the terminal device; and receiving a configuration of a subset of the one or more sensing functionalities for the sensing feature, wherein the subset of the one or more sensing functionalities comprise the at least one sensing functionality. In this way, the terminal device may report its supported functionality(ies) and the network device may configure one or more functionalities supported by the terminal device, thus the reliability of the sensing or communication operation can be improved.

In some example embodiments, the method further comprises: transmitting assistance information associated with a sensing capability of the terminal device. The assistance information comprises at least one updated applicable functionality of the terminal device. In this way, the assistance information can facilitate the network device to activate the applicable functionality of the terminal device, thus the reliability of the sensing or communication operation can be improved.

In some example embodiments, the sensing type is identified based on an index, wherein the index is unique in at least one sensing type for one or more sensing features. In this way, by indicating the sensing type index which is globally unique for all the configured sensing features for the terminal device, the terminal device is aware of the sensing feature associated with the identified sensing type. Thus, the terminal device and the base station have a common understanding on the sensing type and the sensing feature for the sensing or communication operation.

In some example embodiments, the sensing type is identified based on an index of the sensing type and an index of the sensing feature. In this way, by indicating the sensing type index and the sensing feature index, the terminal device is aware of the sensing feature and the identified sensing type associated with the sensing feature. Thus, the terminal device and the base station have a common understanding on the sensing type and the sensing feature for the sensing or communication operation.

In some example embodiments, performing the sensing or communication operation comprises: activating the sensing type; and upon determining that the sensing type is activated, performing the sensing or communication operation. In this way, a scheme of the life cycle management is proposed that the sensing or communication operation is performed for a configured sensing type after the configured sensing type is activated. The sensing type can be pre-configured and can be activated when a corresponding sensing or communication operation is needed, thus the latency of the sensing or communication operation can be reduced.

In some example embodiments, activating the sensing type comprises: receiving an indication of activating the sensing type. In this way, the sensing or communication operation may be performed based on the activated sensing type indicated by the base station. Thus, the reliability of the sensing or communication operation can be improved.

In some example embodiments, the sensing type is a first sensing type associated with at least one first sensing functionality for the sensing feature, and the method further comprises: receiving a configuration of a second sensing type associated with at least one second sensing functionality for the sensing feature. The at least one second sensing functionality is the same as the at least one first sensing functionality; or the at least one second sensing functionality and the at least one first sensing functionality comprise different functionalities. In this way, the terminal device may be configured with multiple sensing types for a sensing feature, thus improving the flexibility of the sensing or communication operation.

In some example embodiments, the method further comprises upon determining that the second sensing type for the sensing feature is being activated when the indication of activating the sensing type is received, deactivating the second sensing type. In this way, an activated sensing type for a sensing feature may be deactivated by activating another sensing type for the same sensing feature. Therefore, only one active sensing type is supported for a sensing feature. The capability required for the sensing or communication operation may be reduced. This scheme may especially apply to terminal devices with limited capability.

In some example embodiments, activating the sensing type comprises: receiving an indication of activating the sensing feature, wherein the sensing type is a default type for the sensing feature. In this way, a default sensing type for the sensing feature may be activated by activating the sensing feature. Thus, the resource overhead for the sensing or communication operation may be reduced.

In some example embodiments, the method further comprises receiving an indication of activating the at least one functionality. The indication of activating the at least one functionality is associated with the sensing type, or the indication of activating the at least one functionality is associated with the sensing feature. In this way, multiple active sensing functionalities may be supported. Thus, latency for the sensing or communication operation may be reduced. This scheme may especially apply to terminal devices with high capability.

In some example embodiments, the at least one sensing functionality comprises a first sensing functionality and a second sensing functionality. Performing the sensing or communication operation comprises: receiving an indication of activating the first sensing functionality; upon determining that the second sensing functionality is being activated when the indication of activating the first sensing functionality is received, deactivating the second sensing functionality; and performing the sensing or communication operation for the first sensing functionality. In this way, the terminal device may be indicated to switch to another sensing functionality for a same sensing feature. By performing different sensing functionalities in different time slots, the terminal device can support the whole sensing feature. This scheme may especially apply to terminal devices with limited capability, e.g., supporting only one sensing functionality at a time slot.

In some example embodiments, the sensing feature is a first sensing feature. The method further comprises: receiving an indication of switching to a second sensing feature; stopping performing the sensing or communication operation for the first sensing feature; and performing a sensing or communication operation for the second sensing feature. In this way, the terminal device may be indicated of switching to another sensing feature, thus improving the flexibility of the sensing or communication operation.

In some example embodiments, the sensing type is a first sensing type. The method further comprises: receiving an indication of switching to a second sensing type for the sensing feature; stopping performing the sensing or communication operation based on the configuration of the sensing type; and performing a sensing or communication operation for the second sensing type. In this way, the terminal device may be indicated of switching to another sensing type for the same sensing feature, thus improving the flexibility of the sensing or communication operation.

In some example embodiments, performing the sensing or communication operation further comprises: upon determining that the sensing type is activated, performing the sensing or communication operation for a first sensing functionality, wherein the first sensing functionality is a default functionality for the sensing type. In this way, a default sensing functionality for the sensing type may be activated by activating the sensing type. Thus, the resource overhead for the sensing or communication operation may be reduced.

In some example embodiments, the at least one sensing functionality comprises a first sensing functionality. Performing the sensing or communication operation further comprises: upon determining that the sensing feature is activated, performing the sensing or communication operation for the first sensing functionality, wherein the first sensing functionality is a default functionality for the sensing feature. In this way, a default sensing functionality for the sensing feature may be activated by activating the sensing feature. Thus, the resource overhead for the sensing or communication operation may be reduced.

In some example embodiments, the method further comprises receiving an indication of disabling the sensing or communication operation. In this way, the user equipment may be indicated to disable the sensing or communication operation. The resource waste of performing the sensing or communication operation may be reduced in case the performance of the currently activated sensing type deteriorates. For example, the network device may determine whether to continue or disable the sensing or communication operation based on the performance of the sensing or communication operation.

In some example embodiments, the method further comprises receiving a monitoring metric for the sensing or communication operation. In this way, the user equipment may monitor the performance of the sensing or communication operation based on the monitoring metric. Compared with transmitting the sensing results to the network device for performance monitoring, the resource overhead for monitoring the performance of the sensing or communication operation may be reduced.

In some example embodiments, the method further comprises receiving a reporting metric for the sensing or communication operation. In this way, the user equipment may determine whether a reporting of the performance of the sensing or communication operation is needed. The user equipment only reports the performance of the sensing or communication operation when needed, thus reducing the resource overhead for reporting.

In some example embodiments, the method further comprises transmitting a request for type switching and an indication of a performance of the sensing or communication operation. In this way, the network device may determine whether a sensing type switching is needed based on the performance of the sensing or communication operation in response to receiving the request from the terminal device. The network device may make the determination considering the overall network conditions, thus improving the accuracy of the sensing or communication operation.

In some example embodiments, the method further comprises: transmitting a request for updating the sensing type; after transmitting the request, receiving training data and ground-truth information for the sensing type; and updating the sensing type based on the training data and the ground-truth information. In this way, a scheme of the life cycle management for updating the sensing type is proposed.

In some example embodiments, the method further comprises: receiving assistance information for fine-tuning the sensing type, wherein the assistance information comprises anchor information for the sensing type; and fine-tuning the sensing type based on the assistance information. In this way, the accuracy of the sensing type may be improved.

In some example embodiments, the sensing type is associated with a function of obtaining information about at least one of characteristics of an environment or characteristics of objects within the environment. In this way, the sensing type is defined.

In some example embodiments, the information about the at least one of characteristics of an environment or characteristics of objects within the environment is a model of at least one of the environment or the objects within the environment. In this way, by performing a sensing or communication operation for the sensing type, a model of an environment or objects within the environment is obtained.

In some example embodiments, a plurality of sensing types comprising the sensing type is associated with the function. In this way, multiple sensing types may be configured for a function of obtaining information about characteristics of an environment or characteristics of objects within the environment, thus improving the flexibility of the sensing or communication operation.

In this way, according to the first aspect and its example embodiments, a sensing functional framework and corresponding air interface procedure can be defined to facilitate sensing or communication operation with high-accuracy, high-flexibility and reduced resource overhead.

In a second aspect, there is provided a method. The method comprises: transmitting, by a network device, a configuration of a sensing type or at least one at least one sensing functionality for a sensing feature; and obtaining a performance of a sensing or communication operation for the sensing type or the at least one sensing functionality. In this way, an air interface procedure for implementing a sensing functional framework is designed.

In some example embodiments, the method further comprises: receiving an indication of the sensing feature and an indication of one or more sensing functionalities associated with the sensing feature, wherein the sensing feature and the one or more functionalities are supported by a terminal device; and transmitting a configuration of a subset of the one or more sensing functionalities for the sensing feature, wherein the subset of the one or more sensing functionalities comprise the at least one sensing functionality. In this way, the terminal device may report its supported functionality(ies) and the network device may configure one or more functionalities supported by the terminal device, thus the reliability of the sensing or communication operation can be improved.

In some example embodiments, the method further comprises: receiving assistance information associated with a sensing capability of a terminal device, wherein the assistance information comprises at least one updated applicable functionality of the terminal device. In this way, the assistance information can facilitate the network device to activate the applicable functionality of the terminal device, thus the reliability of the sensing or communication operation can be improved.

In some example embodiments, the method further comprises: determining to activate the at least one sensing functionality for the sensing feature based on the assistance information; and transmitting an indication of activating the at least one sensing functionality for the sensing feature. In this way, a scheme of activating the sensing functionality may be designed. The reliability of the sensing or communication operation can be improved.

In some example embodiments, the sensing type is identified based on an index, wherein the index is unique in at least one sensing type for one or more sensing features. In this way, based on the sensing type index which is globally unique for all the configured sensing features for the terminal device, the terminal device and the base station have a common understanding on the sensing type and the sensing feature for the sensing or communication operation.

In some example embodiments, the sensing type is identified based on an index of the sensing type and an index of the sensing feature. In this way, based on the sensing type index and the sensing feature index, the terminal device and the base station have a common understanding on the sensing type and the sensing feature for the sensing or communication operation.

In some example embodiments, the method further comprises transmitting an indication of activating the sensing type. In this way, the sensing or communication operation may be performed based on the activated sensing type indicated by the base station. Thus, the reliability of the sensing or communication operation can be improved.

In some example embodiments, the sensing type is a first sensing type associated with at least one first sensing functionality for the sensing feature. The method further comprises transmitting a configuration of a second sensing type associated with at least one second sensing functionality for the sensing feature. The at least one second sensing functionality is the same as the at least one first sensing functionality; or the at least one second sensing functionality and the at least one first sensing functionality comprise different functionalities. In this way, the terminal device may be configured with multiple sensing types for a sensing feature, thus improving the flexibility of the sensing or communication operation.

In some example embodiments, transmitting the indication of activating the sensing type comprises: transmitting an activation indication comprising an identification of the sensing type. In this way, a scheme for activating a sensing type is designed. By transmitting an identification of the sensing type to be activated, the resource overhead for the sensing or communication operation may be reduced.

In some example embodiments, the method further comprises transmitting an indication of activating the sensing feature, wherein the sensing type is a default type for the sensing feature. In this way, a default sensing type for the sensing feature may be activated by activating the sensing feature. Thus, the resource overhead for the sensing or communication operation may be reduced.

In some example embodiments, the method further comprises transmitting an indication of activating the at least one functionality. The indication of activating the at least one functionality is associated with the sensing type, or the indication of activating the at least one functionality is associated with the sensing feature. In this way, multiple active sensing functionalities may be supported. Thus, latency for the sensing or communication operation may be reduced. This scheme may especially apply to terminal devices with high capability.

In some example embodiments, the at least one sensing functionality comprises a first sensing functionality and a second sensing functionality. The method further comprises: determining a switch from the second sensing functionality to the first sensing functionality for the sensing or communication operation; and transmitting an indication of activating the first sensing functionality. In this way, the terminal device may be indicated to switch to another sensing functionality for a same sensing feature. By performing different sensing functionalities in different time slots, the terminal device can support the whole sensing feature. This scheme may especially apply to terminal devices with limited capability, e.g., supporting only one sensing functionality at a time slot.

In some example embodiments, the sensing feature is a first sensing feature. The method further comprises: transmitting an indication of switching to a second sensing feature. In this way, the terminal device may be indicated of switching to another sensing feature, thus improving the flexibility of the sensing or communication operation.

In some example embodiments, the sensing type is a first sensing type. The method further comprises: transmitting an indication of switching to a second sensing type for the sensing feature. In this way, the terminal device may be indicated of switching to another sensing type for the same sensing feature, thus improving the flexibility of the sensing or communication operation.

In some example embodiments, the sensing or communication operation is associated with a first sensing functionality, and the first sensing functionality is a default functionality for the sensing type. In this way, a default sensing functionality for the sensing type may be activated by activating the sensing type. Thus, the resource overhead for the sensing or communication operation may be reduced.

In some example embodiments, the method further comprises transmitting an indication of activating the sensing feature. The at least one sensing functionality comprises a first sensing functionality, and the first sensing functionality is a default functionality for the sensing feature, wherein the sensing or communication operation is associated with the first sensing functionality. In this way, a default sensing functionality for the sensing feature may be activated by activating the sensing feature. Thus, the resource overhead for the sensing or communication operation may be reduced.

In some example embodiments, obtaining the performance of the sensing or communication operation comprises: determining a performance of the sensing type; and determining to activate a third sensing type for the sensing feature or to disable the sensing or communication operation based on the performance of the sensing type. In this way, the network device may monitor the performance of the sensing type and determine whether to continue or disable the sensing or communication operation based on the performance. The resource waste of performing the sensing or communication operation may be reduced in case the performance of the sensing type deteriorates.

In some example embodiments, the method further comprises: transmitting an indication of activating the third sensing type for the sensing feature; or transmitting an indication of disabling the sensing or communication operation. In this way, the user equipment may be indicated to disable the sensing or communication operation or continue the sensing or communication operation with another sensing type. For example, the network device may determine whether to continue or disable the sensing or communication operation. The resource waste of performing the sensing or communication operation may be reduced in case the performance of the currently activated sensing type deteriorates.

In some example embodiments, the method further comprises: transmitting a monitoring metric for the sensing or communication operation. In this way, the user equipment may monitor the performance of the sensing or communication operation based on the monitoring metric. Compared with transmitting the sensing results to the network device for performance monitoring, the resource overhead for monitoring the performance of the sensing or communication operation may be reduced.

In some example embodiments, the method further comprises transmitting a reporting metric for the sensing or communication operation. In this way, the user equipment may determine whether a reporting of the performance of the sensing or communication operation is needed. The resource overhead for reporting may be reduced.

In some example embodiments, the method further comprises receiving a request for type switching and an indication of a performance of the sensing or communication operation. In this way, the network device may determine whether a sensing type switching is needed based on the performance of the sensing or communication operation in response to receiving the request from the terminal device. The network device may make the determination considering the overall network conditions, thus improving the accuracy of the sensing or communication operation.

In some example embodiments, the method further comprises: determining to activate a third sensing type for the sensing feature or to disable the sensing or communication operation based on the performance; and transmitting an indication of activating the third sensing type for the sensing feature or an indication of disabling the sensing or communication operation based on the performance of the sensing or communication operation reported by the terminal device. In this way, the network device may determine whether to continue or disable the sensing or communication operation based on the performance. The resource waste of performing the sensing or communication operation may be reduced in case the performance of the sensing or communication operation deteriorates.

In some example embodiments, the method further comprises: receiving a request for updating the sensing type; and transmitting training data and ground-truth information for the sensing type based on the request. In this way, a scheme of the life cycle management for updating the sensing type is proposed.

In some example embodiments, the method further comprises: transmitting assistance information for fine-tuning the sensing type, wherein the assistance information comprises anchor information for the sensing type. In this way, the accuracy of the sensing type may be improved.

In some example embodiments, the sensing type is associated with a function of obtaining information about at least one of characteristics of an environment or characteristics of objects within the environment. In this way, the sensing type is defined.

In some example embodiments, the information about the at least one of characteristics of an environment or characteristics of objects within the environment is a model of at least one of the environment or the objects within the environment. In this way, by performing a sensing or communication operation for the sensing type, a model of an environment or objects within the environment is obtained.

In some example embodiments, a plurality of sensing types comprising the sensing type is associated with the function. In this way, multiple sensing types may be configured for a function of obtaining information about characteristics of an environment or characteristics of objects within the environment, thus improving the flexibility of the sensing or communication operation.

In this way, according to the second aspect and its example embodiments, a sensing functional framework and corresponding air interface procedure can be defined to facilitate sensing or communication operation with high-accuracy, high-flexibility and reduced resource overhead.

In a third aspect, there is provided a terminal device. The terminal device comprises: a transceiver; and a processor communicatively coupled with the transceiver, wherein the processor is configured to receive, via the transceiver, a configuration of a sensing type or at least one at least one sensing functionality for a sensing feature; and perform a sensing or communication operation based on the configuration of the sensing type or the at least one sensing functionality. In this way, a terminal device capable of implementing a sensing or communication operation for a sensing type or at least one sensing functionality can be obtained to facilitate sensing or communication operation with high-accuracy, high-flexibility and reduced resource overhead.

In a fourth aspect, there is provided a network device. The network device comprises: a transceiver; and a processor communicatively coupled with the transceiver, wherein the processor is configured to transmit, via the transceiver, a configuration of a sensing type or at least one at least one sensing functionality for a sensing feature; and obtaining a performance of a sensing or communication operation for the sensing type or the at least one sensing functionality. In this way, a network device is obtained to support a sensing or communication operation at the terminal device side to facilitate sensing or communication operation with high-accuracy, high-flexibility and reduced resource overhead.

In a fifth aspect, there is provided a non-transitory computer-readable storage medium comprising computer program stored thereon. The computer program, when executed on at least one processor, cause the at least one processor to perform the method of the first or second aspect. In this way, a non-transitory computer-readable storage medium comprising computer program can be provided to support a sensing or communication operation to facilitate sensing or communication operation with high-accuracy, high-flexibility and reduced resource overhead.

In a sixth aspect, there is provided a chip comprising at least one processing circuit configured to perform the method of the first or second aspect. In this way, a chip can be provided to support a sensing or communication operation to facilitate sensing or communication operation with high-accuracy, high-flexibility and reduced resource overhead.

In a seventh aspect, there is provided a computer program product tangibly stored on a computer-readable medium and comprising computer-executable instructions which, when executed, cause an apparatus to perform a method of the first aspect. In this way, the computer program product can be provided to support a sensing or communication operation to facilitate sensing or communication operation with high-accuracy, high-flexibility and reduced resource overhead.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIG. 1B illustrates an example communication system in which some example embodiments of the present disclosure may be implemented;

FIG. 1C illustrates an example of an electric device and a base station in accordance with some example embodiments of the present disclosure;

FIG. 1D illustrates units or modules in a device in accordance with some example embodiments of the present disclosure;

FIG. 1E illustrates an example sensing system in accordance with some example embodiments of the present disclosure;

FIG. 1F illustrates an example apparatus that may implement the methods and teachings in accordance with some example embodiments of the present disclosure;

FIG. 2 illustrates a flowchart illustrating an example communication process in accordance with some example embodiments of the present disclosure;

FIG. 3 illustrates a schematic diagram of an example sensing functional framework in accordance with some embodiments of the present disclosure;

FIG. 4 illustrates a schematic diagram of an example sensing feature in accordance with some embodiments of the present disclosure;

FIG. 5 illustrates a block diagram of an electronic device that may be used for implementing devices and methods in accordance with some embodiments of the present disclosure;

FIG. 6 illustrates an example of a method implemented at a terminal device in accordance with some embodiments of the present disclosure;

FIG. 7 illustrates an example of a method implemented at a network device in accordance with some embodiments of the present disclosure.

FIG. 8 illustrates a schematic diagram of a structure of an apparatus in accordance with some embodiments of the present disclosure;

FIG. 9 illustrates a schematic diagram of a structure of another apparatus in accordance with some embodiments of the present disclosure.

Throughout the drawings, the same or similar reference numerals represent the same or similar elements.

### DETAILED DESCRIPTION OF THE ILLUSTRATIVE EMBODIMENTS

Principles of the present disclosure will now be described with reference to some example embodiments. It is to be understood that these embodiments are described for the purpose of illustration and help those skilled in the art to understand and implement the present disclosure, without suggesting any limitation as to the scope of the disclosure. Embodiments of the disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Wireless Fidelity (WiFi) and so on. Furthermore, the communications between a terminal device and a network device in the communication network may be performed according to any suitable generation communication protocols, including, but not limited to, the fourth generation (4G), 4.5G, the future fifth generation (5G), IEEE 802.11 communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a WiFi device, a relay, a low power node such as a femto, a pico, and so forth, depending on the applied terminology and technology. In the following description, the terms “network device”, “AP device”, “AP” and “access point” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a station (STA) or station device, or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a VR (virtual reality) device, an XR (extended reality) device, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “station”, “station device”, “STA”, “terminal device”, “communication device”, “terminal”, “user equipment” and “UE” may be used interchangeably.

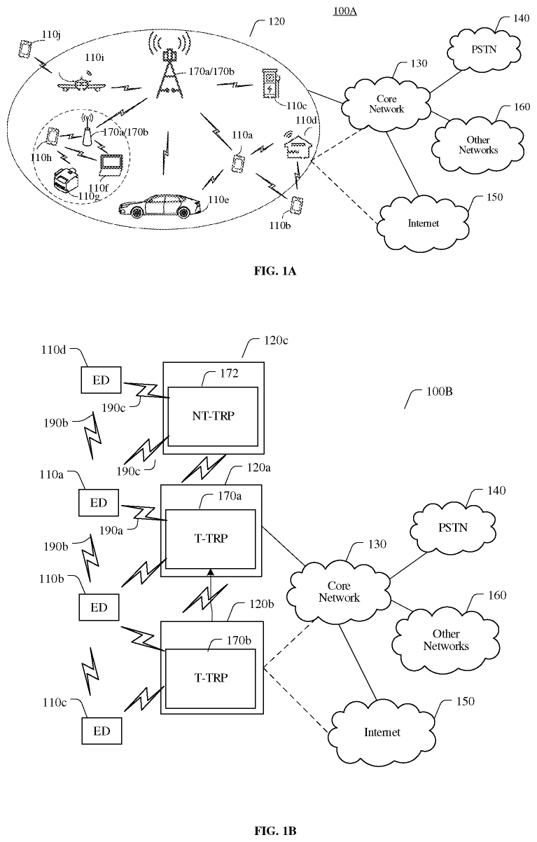

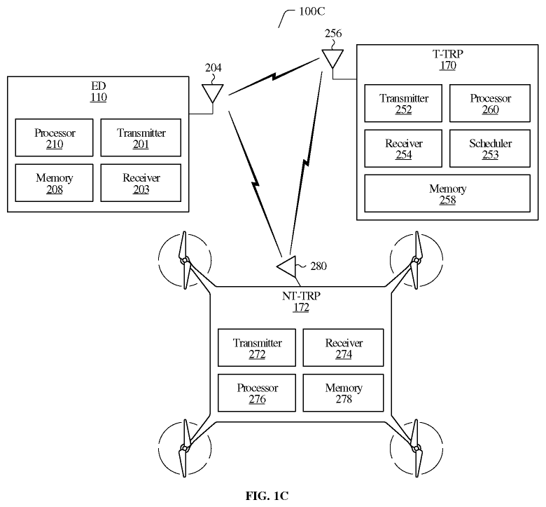

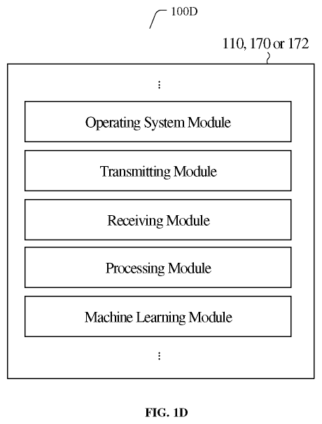

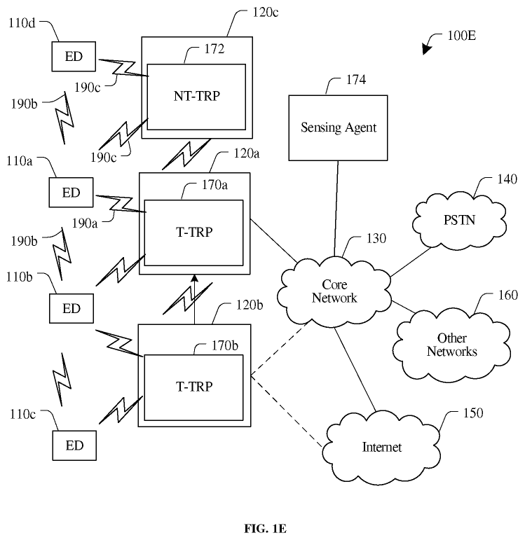

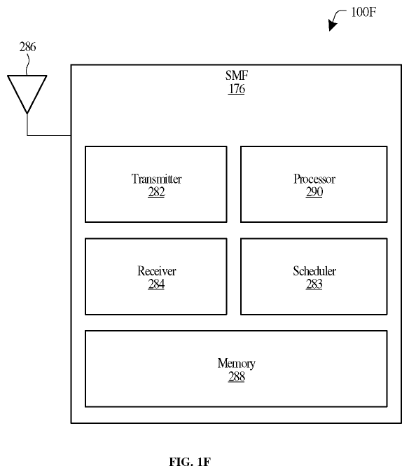

Referring to FIG. 1A, as an illustrative example without limitation, a simplified schematic illustration of a communication system 100A is provided. The communication system 100A comprises a radio access network 120. The radio access network 120 may be a next generation (e.g. sixth generation (6G) or later) radio access network, or a legacy (e.g. 5G, 4G, 3G or 2G) radio access network. One or more communication user equipment (UE, also referred to as electric device (ED)) 110a-110j (generically referred to as 110) may be interconnected to one another or connected to one or more network nodes (170a, 170b, generically referred to as 170) in the radio access network 120. A core network 130 may be a part of the communication system 100A and may be dependent or independent of the radio access technology used in the communication system 100A. Also the communication system 100A comprises a public switched telephone network (PSTN) 140, the internet 150, and other networks 160. The other networks 160 may include a multi-access edge computing (MEC) platform.

FIG. 1B illustrates an example communication system 100B. In general, the communication system 100B enables multiple wireless or wired elements to communicate data and other content. The purpose of the communication system 100B may be to provide content, such as voice, data, video, and/or text, via broadcast, multicast and unicast, etc. The communication system 100B may operate by sharing resources, such as carrier spectrum bandwidth, between its constituent elements. The communication system 100B may include a terrestrial communication system and/or a non-terrestrial communication system. The communication system 100B may provide a wide range of communication services and applications (such as earth monitoring, remote sensing, passive sensing and positioning, navigation and tracking, autonomous delivery and mobility, etc.). The communication system 100B may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system 100B. In the example shown, the communication system 100B includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node, which may be generically referred to as a non-terrestrial transmit and receive point (NT-TRP) 172. As described above, the other networks 160 may include a multi-access edge computing (MEC) platform.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100B may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a, 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a, 110b, and 110c or both, and (ii) other networks (such as the PSTN 140, the internet 150, and the other networks 160). In addition, some or all of the EDs 110a, 110b, and 110c may include functionality for communicating with different wireless networks over different wireless links using different wireless technologies and/or protocols. Instead of wireless communication (or in addition thereto), the EDs 110a, 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a, 110b, and 110c may be multimode devices capable of operation according to multiple radio access technologies, and incorporate multiple transceivers necessary to support such.

FIG. 1C illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

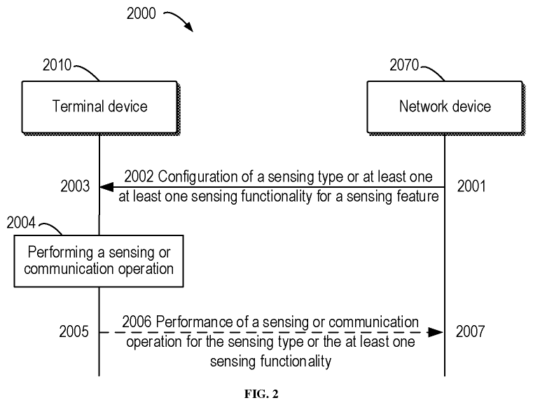

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1A). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 1D. FIG. 1D illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:

(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.

(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.

(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.

(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.

(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

The concept of cell, carrier, bandwidth parts (BWPs) and occupied bandwidth will be described below.

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xx0:yy0:zz), to a frame boundary, where xx0, yy0, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively, or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, i.e., Δt, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

A generic background for 6G integrated sensing and communication will now be described. User Equipment (UE) position information is often used in cellular communication networks to improve various performance metrics for the network. Such performance metrics may, for example, include capacity, agility, and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including its location in a global coordinate system, its velocity and direction of movement in the global coordinate system, orientation information, and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency, or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems

Any or all of the EDs 110 and BS 170 may be sensing nodes in the communication system 100E as illustrated in FIG. 1E, which is an example sensing system in accordance with some example embodiments of the present disclosure. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. FIG. 1E differs from FIG. 1B in that there is a sensing agent 174 in the communication system 100E, which is absent in FIG. 1B. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100E. The sensing agent 174 may be in communication with the core network 130 to communicate information with the rest of the communication system 100E. By way of example, the sensing agent 174 may determine the location of the ED 110a, and transmit this information to the base station 170a via the core network 130. Although only one sensing agent 174 is shown in FIG. 1E, any number of sensing agents may be implemented in the communication system 100E. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

FIG. 1F illustrates an example apparatus 100F that may implement the methods and teachings according to this disclosure. In particular, FIG. 1F illustrates an example SMF 176, which may be implemented in a UE 110, a system node 120, or a network node 130. As will be discussed further below, the SMF 176 may be specialized, or include specialized components, to support training and/or execution of AI models (e.g., training and/or execution of neural networks).

As shown in FIG. 1F, the SMF 176, when implemented as a physically independent entity, includes at least one processor 290, at least one transmitter 282, at least one receiver 284, one or more antennas 286, and at least one memory 288. A transceiver, not shown, may be used instead of the transmitter 282 and receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing, or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array, or application specific integrated circuit.

A reference signal-based pose determination technique belongs to an “active” pose estimation paradigm. In an active pose estimation paradigm, the enquirer of pose information (i.e., the UE) takes part in process of determining the pose of the enquirer. The enquirer may transmit or receive (or both) a signal specific to pose determination process. Positioning techniques based on a global navigation satellite system (GNSS) such as Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space based sensing to reduce sensing complexity and improve sensing accuracy. In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal, and a second set of channels may be used to transmit a communications signal. In some embodiments, each channel in the first set of channels and each channel in the second set of channels is a logical channel, a transport channel, or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) is used to carry control information for both sensing and communication. Alternatively, separate physical layer control channels may be used to carry separate control information for communication and sensing. For example, PUCCH-S and PUCCH-C could be used for uplink control for sensing and communication respectively, and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (i.e., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static, or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g. in the millimeter wave bands), and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Sensing signal waveform and frame structure will now be described. Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of

$$f - {f}_{chirp 0} = α ( t - {t}_{chirp 0} ) , where α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding as used herein may refer to any coding operation(s) or modulation(s) that transform an input signal into an output signal. Precoding may be performed in different domains, and typically transform the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

Multiple input multiple-output (MIMO) technology allows an antenna array of multiple antennas to perform signal transmissions and receptions to meet high transmission rate requirement. The above ED110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves for dozens of the ED 110 (such as 40) in the meanwhile. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and an ED 110 is obviously reduced, and the power efficiency is greatly increased. When the antenna number of the T-TRP 170, and/or NT-TRP 172 is sufficiently large, random channels between each ED 110 and the T-TRP 170, and/or NT-TRP 172 can approach to be orthogonal, and the interference between the cell and the users and the effect of noises can be eliminated. The plurality of advantages described above enable the large-scale MIMO to have a magnificent application prospect.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:

Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

Artificial Intelligence technologies can be applied in communication, including artificial intelligence or machine learning (AI/ML) based communication in the physical layer and/or AI/ML based communication in the higher layer, e.g., medium access control (MAC) layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, e.g. to optimize the functionality in the MAC layer, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

The following are some terminologies which are used in AI/ML field:

Data collection: Data is the very important component for AI/ML techniques. Data collection is a process of collecting data by the network nodes, management entity, or UE for the purpose of AI/ML model training, data analytics and inference.

AI/ML model training: AI/ML model training is a process to train an AI/ML Model by learning the input/output relationship in a data driven manner and obtain the trained AI/ML Model for inference.

AI/ML model inference: A process of using a trained AI/ML model to produce a set of outputs based on a set of inputs.

AI/ML model validation: As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

AI/ML model testing: Similar with validation, testing is also a sub-process of training, and it is used to evaluate the performance of a final AI/ML model using a dataset different from the one used for model training and validation. Differently from AI/ML model validation, testing do not assume subsequent tuning of the model.

Online training: Online training means an AI/ML training process where the model being used for inference is typically continuously trained in (near) real-time with the arrival of new training samples.

Offline training: An AI/ML training process where the model is trained based on collected dataset, and where the trained model is later used or delivered for inference.

AI/ML model delivery/transfer: A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

Life cycle management (LCM): When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report. Model monitoring can be based on inference accuracy, including metrics related to intermediate key performance indicator (KPI) s, and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to the environment changes, thus the model based on input or output data distribution should also be considered.

Supervised learning: The goal of supervised learning algorithms is to train a model that maps feature vectors (inputs) to labels (output), based on the training data which includes the example feature-label pairs. The supervised learning can analyze the training data and produce an inferred function, which can be used for mapping the inference data. Supervised learning can be further divided into two types: Classification and Regression. Classification is used when the output of the AI/ML model is categorical i.e. with two or more classes. Regression is used when the output of the AI/ML model is a real or continuous value.

Unsupervised learning: In contrast to supervised learning where the AI/ML models learn to map the input to the target output, the unsupervised methods learn concise representations of the input data without the labelled data, which can be used for data exploration or to analyze or generate new data. One typical unsupervised learning is clustering which explores the hidden structure of input data and provide the classification results for the data.

Reinforce learning: Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent can take the next action based on the received reward and new state in the environment. During the training phase, the agent interacts with the environment to collect experience. The environments often mimicked by the simulator since it is expensive to directly interact with the real system. In the inference phase, the agent can use the optimal decision-making rule learned from the training phase to achieve the maximal accumulated reward.

Federated learning: Federated learning (FL) is a machine learning technique that is used to train an AI/ML model by a central node (e.g., server) and a plurality of decentralized edge nodes (e.g., UEs, next Generation NodeBs, “gNBs”).

According to the wireless FL technique, a server may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure is performed multiple iterations until the global AI/ML model is considered to be finalized, e.g., the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

An AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, e.g. to optimize one or more components of the air interface, will be referred to herein as an “AI enabled air interface”. In some embodiments, there may be two types of AI operation in an AI enabled air interface: both the network and the UE implement learning; or learning is only applied by the network.

Sensing is a process of obtaining surrounding information. Sensing can be broadly classified as RF sensing and non-RF sensing. The RF sensing is a process of sending a RF signal and obtaining the surrounding information either by receiving and processing of this RF signal or the echoed (reflected) RF signal. The non-RF sensing is a process of obtaining the surrounding information via a non-RF signal such as video camera or other sensors. In this disclosure, the term “sensing” refers to RF-sensing if it is not specified.

Sensing can be used to detect the information of an object, such as location, speed, distance, orientation, shape, texture etc. Sensing can be classified as active sensing (also referred to as device based sensing) and passive sensing (also referred to as device free sensing). In active sensing, a sensor sends a RF signal to the sensed object, which is capable of detecting the RF signal and obtaining sensed information from the RF signal or measuring some intermediate info, which is fed back to the sensor to assist the sensor to obtain sensed info. In passive sensing, a sensor sends a RF signal to the sensed object and detects the reflected echo of the RF signal, and obtains the sensed information from the echo. The object may or may not contain certain identification (ID) information (e.g., a RF tag), such as ambient IoT device. As an example of a passive sensing, a radar system sends a RF signal to localize, detect and track a target. Typically, the radar system is a standalone system and designed for a specific application.

Generally, from the transmitter and receiver point of view, there are three types of sensing, namely, monostatic sensing, bi-static sensing and multi-static sensing. In monostatic sensing, the transmitter and receiver are the same device. In bi-static sensing, the transmitter and receiver are different devices. For example, the BS sends the sensing signals, and the UE receives the sensing signals. In multi-static sensing, the transmitter(s) and the receiver(s) can be decomposed into a set of N bi-static Tx-Rx pairs, where N>1. For example, a BS sends the sensing signals, and two UEs (including UE1, UE2) receives the sensing signals. A first bi-static Tx-Rx pair includes the BS and the UE1, and a second bi-static Tx-Rx pair includes the BS and the UE2.

An integrated sensing and communication (ISAC) system is a system which reuses the communication RF signal for sensing. The ISAC system is a networked and cooperative sensing system instead of a single standalone radar system. Cooperating sensing can be done via the integrated communication protocols. A functional framework for sensing, e.g. sensing in ISAC, especially the air interface procedure for sensing management, needs to be designed.

FIG. 2 illustrates a flowchart of an example process 2000 implemented in a sensing functional framework in accordance with some example embodiments of the present disclosure. For the purpose of discussion, the process 2000 will be described with reference to FIGS. 1A-1F. The process 2000 may involve a terminal device 2010 and a network device 2070. The terminal device 2010 may be implemented as the ED 110 in FIGS. 1A-1E. The network device 2070 may be implemented as the T-TRP 170 in FIGS. 1A-1E or the NT-TRP 172 in FIGS. 1B-1E. It is to be understood that the steps and the order of the steps in FIG. 2 are merely for illustration, and not for limitation. It is to be understood that process 2000 may further include additional blocks not shown and/or omit some shown blocks, and the scope of the present disclosure is not limited in this regard. The process 2000 may involve a sensing functional framework, an example of which will be described in more detail with reference to FIG. 3.

As illustrated in FIG. 2, the network device 2070 transmits 2001 a configuration 2002 of a sensing type or at least one sensing functionality for a sensing feature. The terminal device 2010 receives 2003 the configuration 2002 and performs 2004 a sensing or communication operation based on the configuration 2002. The network device 2070 obtains 2005 a performance of the sensing or communication operation for the sensing type or the at least one sensing functionality. For example, the terminal device 2010 may perform a sensing operation. Alternatively, the terminal device 2010 may perform a communication operation where sensing results may assist the terminal device 2010 to perform the communication operation.

In some embodiments, the sensing type is associated with a function of obtaining information about at least one of characteristics of an environment or characteristics of objects within the environment. The sensing type may be a sensing model or a sensing result. In the embodiments of the present disclosure, when referring to “a sensing type”, “a sensing model” or “a sensing result” may be interchangeably used. In some embodiments, the information about the at least one of characteristics of an environment or characteristics of objects within the environment is a model of at least one of the environment or the objects within the environment. For example, the sensing type may be associated with a function that reconstructs the physical world, including environment reconstruction, channel reconstruction (e.g. by ray tracing scheme), target reconstruction, digital twin, etc. The information obtained for the sensing type may be a model of the environment and/or the objects, or a sensing result of the environment and/or the objects. In some embodiments, a plurality of sensing types comprising the sensing type is associated with the function. As an example, the terminal device 2010 may be configured with multiple sensing models for reconstructing the physical worlds.

In some embodiments, the sensing type is identified based on an index, wherein the index is unique in at least one sensing type for one or more sensing features. For example, in a sensing feature, there may be one or multiple sensing types, each sensing type is configured with a respective ID. The sensing type ID may be globally unique for all the configured sensing features for the terminal device 2010. In this way, by indicating the sensing type ID, the terminal device 2010 knows the associated sensing feature.

In some embodiments, the sensing type is identified based on an index of the sensing type and an index of the sensing feature. For example, in a sensing feature, there may be one or multiple sensing types, each sensing type is configured with a respective ID. The sensing type ID may be locally unique within the sensing feature.

In some embodiments, the terminal device 2010 may transmit an indication of the sensing feature and an indication of one or more sensing functionalities associated with the sensing feature to the network device 2070. The sensing feature and the one or more functionalities are supported by the terminal device 2010. The network device 2070 may transmit a configuration of a subset of the one or more sensing functionalities for the sensing feature. The subset of the one or more sensing functionalities comprise the at least one sensing functionality. In other words, the terminal device 2010 may report its supported sensing feature and supported sensing functionality(ies). The network device 2070 may configure one or multiple functionalities which are supported by the terminal device 2010 for a sensing feature according to the capability of the terminal device 2010. Throughout the disclosure, the term “subset” may be understood as all or a part.

In some embodiments, the terminal device 2010 may transmit assistance information associated with a sensing capability of the terminal device 2010 to the network device 2070. The assistance information comprises at least one updated applicable functionality of the terminal device 2010. The network device 2070 may determine to activate the at least one sensing functionality for the sensing feature based on the assistance information and transmit an indication of activating the at least one sensing functionality for the sensing feature to the terminal device 2010. For example, due to change of memory, battery, and other hardware, the applicable functionality(ies) of the terminal device 2010 for the sensing feature may be changed accordingly. The terminal device 2010 may transmit assistance information to report its updated applicable functionality(ies). The network device 2070 may activate one or more applicable functionalities accordingly.

In some embodiments, in order to perform the sensing or communication operation, the terminal device 2010 may activate the sensing type. Upon determining that the sensing type is activated, the terminal device 2010 may perform the sensing or communication operation. In some example implementations, the terminal device 2010 may receive an indication of activating the sensing type and then activate the sensing type. In a more specific example, the indication of activating the sensing type may comprise an activation indication comprising an identification of the sensing type.

In some embodiments, the sensing type is a first sensing type associated with at least one first sensing functionality for the sensing feature. The terminal device 2010 may receive a configuration of a second sensing type associated with at least one second sensing functionality for the sensing feature. The at least one second sensing functionality may be the same as the at least one first sensing functionality. Alternatively, the at least one second sensing functionality and the at least one first sensing functionality comprise different functionalities. For example, in a sensing type for a sensing feature, there may be one or multiple functionalities associated to the sensing type. For different sensing types, same or different functionalities may be associated.

In some embodiments, if the second sensing type for the sensing feature is being activated when the indication of activating the first sensing type is received, the terminal device 2010 may deactivate the second sensing type. In other words, for a sensing feature, only one active sensing type is supported. The network device 2070 may indicate type switching by transmitting an indication of the sensing type to be activated and the currently activated sensing type may be deactivated accordingly.

In some embodiments, in order to activate the sensing type, the terminal device 2010 may receive an indication of activating the sensing feature, wherein the sensing type is a default type for the sensing feature. In other words, there may be a default sensing type for a sensing feature. When the sensing feature is activated, the default sensing type of the sensing feature may be activated.

In some embodiments, the terminal device 2010 may receive an indication of activating the at least one functionality. The indication of activating the at least one functionality is associated with the sensing type. For example, for a sensing type, one or multiple active sensing functionalities are supported. The network device 2070 may indicate the activation of one or more sensing functionalities for a sensing type. In other words, the activation of the functionalities may be sensing type-specific. Alternatively, the indication of activating the at least one functionality is associated with the sensing feature. For example, the network device 2070 may indicate activation of multiple sensing functionalities for a sensing feature. In other words, the activation of the functionalities may be sensing feature-specific. For a terminal device with high capability, multiple active sensing functionalities can reduce sensing latency.

In some embodiments, the at least one sensing functionality comprises a first sensing functionality and a second sensing functionality. The network device 2070 may determine a switch from the second sensing functionality to the first sensing functionality for the sensing or communication operation and transmit an indication of activating the first sensing functionality to the terminal device 2010. The terminal device 2010 may receive the indication of activating the first sensing functionality. If the second sensing functionality is being activated when the indication of activating the first sensing functionality is received, the terminal device 2010 may deactivate the second sensing functionality and performing the sensing or communication operation for the first sensing functionality. In other words, a terminal device may support only one sensing functionality at a time slot. The network device may indicate switching of sensing functionality for a same sensing feature by indicating activation of a sensing functionality to be activated. By performing different sensing functionalities in different time slots, the terminal device may support the whole sensing feature.

In some embodiments, the sensing feature is a first sensing feature. The terminal device 2010 may receive an indication of switching to a second sensing feature from the network device 2070, stop performing the sensing or communication operation for the first sensing feature; and perform a sensing or communication operation for the second sensing feature. In other words, the network device may indicates switching of sensing features. As a specific example, assuming the terminal device 2010 is currently performing environment reconstruction sensing feature. After the static environment reconstruction is finished, the network device 2070 may indicate the terminal device 2010 to switch to moving object detection to obtain the moving target information in the environment.

In some embodiment, the sensing type is a first sensing type. The terminal device 2010 may receive an indication of switching to a second sensing type for the sensing feature from the network device 2070, stop performing the sensing or communication operation based on the configuration of the sensing type, and perform a sensing or communication operation for the second sensing type. In other words, the network device 2070 may indicate switching of sensing type for a sensing feature. As a specific example, for a sensing feature of object detection, the first sensing type is for mono-static sensing, the second sensing type is for bi-static sensing where the terminal device is a sensing transmitter, and the third sensing type is for bi-static sensing where the terminal device is a sensing receiver. The network device 2070 may indicate the terminal device 2010 to switch from the second sensing type to the third sensing type according to the sensing frame structure.

In some embodiments, upon determining that the sensing type is activated, the terminal device 2010 may perform the sensing or communication operation for a first sensing functionality, wherein the first sensing functionality is a default functionality for the sensing type. In other words, there may be a default sensing functionality for a sensing type. When the sensing type is activated, the default sensing functionality of the sensing type may be activated. For example, there may be a default active functionality when the sensing type is enabled for the terminal device. The identification (ID) of the default active functionality for the sensing type may be configured or predefined. In some embodiments, there may be multiple default active functionalities when the sensing type is enabled for the terminal device.

In some embodiments, the at least one sensing functionality comprises a first sensing functionality. The network device 2070 may transmit an indication of activating the sensing feature. Upon determining that the sensing feature is activated, the terminal device 2010 may perform the sensing or communication operation for the first sensing functionality, wherein the first sensing functionality is a default functionality for the sensing feature. In other words, there may be a default sensing functionality for a sensing feature. When the sensing feature is activated, the default sensing functionality of the sensing feature may be activated. For example, there may be a default active functionality when the sensing feature is enabled for the terminal device. The identification (ID) of the default active functionality for the sensing feature may be configured or predefined. In some embodiments, there may be multiple default active functionalities when the sensing feature is enabled for the terminal device.

In some embodiments, when obtaining the performance of the sensing or communication operation, the network device 2070 may determine a performance of the sensing type, and determine to activate a third sensing type for the sensing feature or to disable the sensing or communication operation based on the performance of the sensing type. The network device 2070 may transmit an indication of activating the third sensing type for the sensing feature or an indication of disabling the sensing or communication operation. Accordingly, the terminal device 2010 may receive an indication of disabling the sensing or communication operation from the network device 2070. In other words, the sensing monitoring may be implemented at the network device side. The network device may indicate a sensing type switching or disabling of the sensing based on the monitoring results.

In some embodiments, the terminal device 2010 may receive a monitoring metric for the sensing or communication operation from the network device 2070. For example, the terminal device 2010 may monitor and evaluate the performance of the sensing or communication operation based on the monitoring metric. If the terminal device 2010 finds the sensing type if not applicable, the terminal device 2010 may request to switch or update or deactivate the sensing type. In a specific example, if a sensing type for static environment map is activated for a sensing feature of channel prediction, when the terminal device 2010 senses that there are multiple surrounding moving targets, the terminal device 2010 may request to switch to another sensing type or fallback to a non-sensing mode. In another specific example, if a sensing type for environment map (site-specific map) is activated for a sensing feature of channel prediction, when the terminal device 2010 moves to another site, the terminal device 2010 may request to switch to another sensing type for environment map of another site.

In some embodiments, the terminal device 2010 may receive a reporting metric for the sensing or communication operation. For example, the terminal device 2010 may monitor the performance of the sensing or communication operation and report the performance of the sensing or communication operation when the performance fulfils the reporting metric. In this way, the terminal device 2010 does not need to report unnecessary information of the sensing or communication operation to the network device 2070.

In some embodiments, the terminal device 2010 may transmit a request for type switching and an indication of a performance of the sensing or communication operation to the network device 2070. The network device 2070 may determine to activate a third sensing type for the sensing feature or to disable the sensing or communication operation based on the performance, and transmit an indication of activating the third sensing type for the sensing feature or an indication of disabling the sensing or communication operation to the terminal device 2010. In other words, the sensing monitoring may be implemented at the terminal device side. According to the report from the terminal device, the network device may indicate a sensing type switching or disabling of the sensing based on the monitoring results.

In some embodiments, the terminal device 2010 may transmit a request for updating the sensing type to the network device 2070. After receiving the request, the network device 2070 may transmit training data and ground-truth information for the sensing type to the terminal device 2010. The terminal device 2010 may update the sensing type based on the training data and the ground-truth information. In other words, the terminal device may transmit a sensing type update request to the network device, and the network device may transmit training data and associated ground-truth information to the terminal device to assist it to update the sensing type. In this way, the sensing parameters may be flexibly updated as the scenario/configuration/site that the device experiences changes over time. The accuracy of the sensing type may be improved.

In some embodiments, the terminal device 2010 may receive assistance information for fine-tuning the sensing type from the network device 2070 and fine-tune the sensing type based on the assistance information. The assistance information comprises anchor information for the sensing type. For example, the network device 2070 may transmit information of an anchor device which has a known location to the terminal device 2010. The terminal device 2010 may calibrate the sensing results based on the information of the anchor device.

FIG. 3 illustrates a schematic diagram of an example sensing functional framework 300 in accordance with some embodiments of the present disclosure. It is to be understood that sensing functional framework 300 may further include additional blocks not shown and/or omit some shown blocks, and the scope of the present disclosure is not limited in this regard.

As shown in FIG. 3, the sensing functional framework 300 may include physical entities implementing a sensing data collection function 301, a sensing modelling function 302, a sensing management function 303, a sensing application function 304 and a sensing results storage function 305. It should be understood that the terms for these functions are merely for illustration without suggesting any limitation. the sensing data collection function 301 may also be referred to as a data collection function, a 3GPP sensing data collection function 301, a 3GPP and non-3GPP sensing data collection function 301, a data measurement function, or a sensing measurement function, etc. the sensing modelling function 302 may also be referred to as a sensing results processing function, a sensing information processing function, a sensing data processing function, a sensing measurement processing function, an environment information processing function, an object information processing function, an environment and object information processing function, etc. the sensing management function 303 may also be referred to as a sensing control function, a sensing results management function, etc. the sensing application function 304 may also be referred to as a sensing action function, a sensing in RAN function, a sensing usage function, a sensing use cases function, a sensing assisted communication function, a sensing service function, a sensing assisted communication and sensing service function, etc. the sensing results storage function 305 may also be referred to as a sensing storage function, a RAN storage function, a local RAN storage function, a RAN and core network storage function, etc.

The sensing data collection function 301 may be configured to provide input data to the sensing modelling function 302, the sensing management function 303 and the sensing application function 304. Examples of the input data provided by the sensing data collection function 301 to other functions may include measurements from UEs or different network entities, where the measurements may be RF sensing measurements or non-RF sensing (e.g., light detection and ranging (LIDAR), camera, video, sensor, etc.) measurements.

For example, the sensing data collection function 301 may provide sensing data for modeling 311 to the sensing modelling function 302. The sensing data for modeling 311 may also be referred to as training data. The sensing data for modeling 311 may include data needed as input for the sensing modelling function 302, e.g. data for sensing analysis. For example, the sensing data for modeling 311 may include assistance information for the sensing modeling function 302.

The sensing data collection function 301 may provide monitoring data 312 to the sensing management function 303. The monitoring data 312 may include data needed as input for the sensing management function 303.

The sensing data collection function 301 may provide action data 313 to the sensing application function 304. The action data 313 may include data needed as input for the sensing application function 304.

In some embodiments, the sensing modelling function 302 may be configured to reconstruct the physical world (i.e., get a model for the physical world), including environment reconstruction, channel reconstruction (e.g. by ray tracing scheme), target reconstruction, digital twin, etc. After obtaining the sensing results, the sensing modelling function 302 may deliver the sensing results 314 (e.g., a trained sensing model or an updated sensing model) to the sensing results storage function 305. Alternatively or additionally, the output 314 (e.g., partial sensing results) of sensing modeling function 302 may be delivered to the core network or the 3rd party 306, so as to provide a sensing service to the core network or the 3rd party 306 by RAN. In the present disclosure, the sensing results or the sensing model may be collectively referred to as a sensing type.

In some embodiments, the sensing modelling function 302 may be enabled by AI, e.g. using AI to derive the sensing results. The sensing modelling function 302 may be able to request specific information to be used to train the sensing model and to avoid reception of unnecessary information. In some embodiments, the sensing modelling function 302 may be responsible for data processing, e.g. data pre-processing and cleaning, formatting, and transformation based on the training data delivered by the sensing data collection function 301, if required.

In some embodiments, the sensing management function 303 may be responsible for performing sensing control to the sensing modelling function 302 and the sensing application function 304, and may monitor the sensing output of the sensing application function 304. If the sensing results are no longer applicable, the sensing management function 303 may request the sensing modelling function 302 to re-train the sensing model, and the sensing management function 303 may indicate the sensing application function 304 to switch the sensing model.

In some embodiments, the sensing management function 303 may be configured to receive the monitoring data 312 (e.g. the ground truth data) from the sensing data collection function 301. After comparing the sensing output and the ground truth by the sensing management function 303, the sensing performance may be evaluated. In some embodiments, the sensing management function 303 may be configured to receive the output 317 of the sensing application function 304. The output 317 of the sensing application function 304 may include the performance of the sensing application function 304.

In some embodiments, if certain information derived from sensing application function 304 or information derived from the performance monitoring in the sensing management function 303 is suitable for improvement of the sensing model trained in the sensing modelling function 302, the sensing management function 303 may transmit a performance feedback message or a re-model request 315 to the sensing modelling function 302. For example, when the sensing management function 303 observes that the sensing performance of current sensing model is not good enough, the sensing management function 303 may transmit a performance feedback message or a re-model request 315 to the sensing modelling function 302. In a more specific example, for channel construction, a sensing model may be generated according to a static environment map, but when there are many moving targets in the environment, causing too much signal refection, the channel construction model is inapplicable. In this case, the sensing management function 303 may transmit current sensing performance to the sensing modelling function 302, including current sensing output and its accuracy, resolution, etc. Additionally or alternatively, the sensing management function 303 may request the sensing modelling function 302 to retrain the model, and request to get an updated sensing model.

In some embodiments, the sensing management function 303 may transmit a sensing model selection/(de) activation/switching/fallback message 318 to the sensing application function 304. For example, when the sensing management function 303 observes that the sensing performance of current sensing model is not good enough, the sensing management function 303 may transmit a model switching signalling to the sensing application function 304 to indicate the sensing application function 304 to switch to another sensing model, or may transmit a fallback signalling to indicate the sensing application function 304 to use a non-sensing mode. In some embodiments, when there are multiple candidate sensing models, the sensing management function 303 may indicate the sensing application function 304 to use which sensing model, and activate or de-activate one or multiple the candidate sensing models.

In some embodiments, the sensing management function 303 may transmit a sensing results transfer or sensing model transfer request 316 to the sensing results storage function 305 to request a model for the sensing application function 304. The sensing results transfer or sensing model transfer request 316 may be an initial model transfer request or an updated model transfer request.

In some embodiments, the sensing application function 304 may be configured to provide an output 317 to the sensing management function 303. For example, the sensing application function 304 may be configured to provide sensing decision output or sensing inference output (e.g. predictions or detections). Some examples are target detection, channel prediction. The sensing application function 304 may also be responsible for performing actions according to the sensing results. For example, the sensing application function 304 may trigger or perform corresponding actions according to the sensing decision or prediction, and may trigger actions directed to other entities or to itself. The sensing application function 304 may also be also responsible for data preparation (e.g. data pre-processing and cleaning, formatting, and transformation) based on the action data 313 delivered by the data collection function 301.

The sensing application function 304 may produce outputs of the sensing model and signal the outputs of the sensing model to nodes that have explicitly requested them (e.g., via subscription), or nodes that are subject to actions based on the output from sensing application function 304.

The sensing results storage function 305 may be configured to store the sensing models, e.g. the reconstructed physical world (e.g. environment map, target and its location). The storage location may be within RAN (e.g. BS and/or UE side), or outside RAN (e.g. core network or the third party). The sensing results storage function 305 may receive the sensing results 314 (e.g., the sensing model) from the sensing modelling function 302. The model may be the first trained model, or the re-trained/updated model.

The sensing results storage function 305 may receive a sensing results transfer or sensing model transfer request 316 from the sensing management function 303. After receiving the sensing results transfer or sensing model transfer request 316, the sensing results storage function 305 may perform sensing results transfer or sensing model transfer 319 to the sensing application function 304. For example, the sensing results storage function 305 may transmit the corresponding sensing results or sensing model to the sensing application function 304 based on the sensing results transfer or sensing model transfer request 316. In some embodiments, the sensing results transfer or sensing model transfer request 316 may indicate the requested result ID or model ID, and the sensing results storage function 305 transmit the model with the requested model ID. Alternatively, the sensing results transfer or sensing model transfer request 316 may indicate the sensing functionality ID and/or sensing performance requirement (e.g. sensing accuracy, sensing distance/speed/angle resolution), then the sensing results storage function 305 may deliver a model satisfying the indicated sensing functionality and/or the sensing performance requirement.

It should be understood that the physical entity of the functions in the sensing functional framework 300 may be implemented in various manners. For example, the physical entity of a sensing function in the sensing functional framework 300 may be located in a UE, a BS, the core network, or the 3rd party. The physical entities of different sensing functions may be located at the same physical entity or different physical entities.

Hereinbefore, the sensing functional framework 300 supporting sensing procedure in the network is illustrated from the perspective view of each function. Hereinafter, an air interface procedure in the sensing functional framework 300 will be described in detail from the perspective view of a LCM of sensing. The LCM of sensing is characterized, e.g., sensing modelling, sensing action, sensing monitoring, sensing update. The sensing LCM may be implemented as a sensing functionality-based LCM or a sensing type-based LCM. In the sensing functionality-based LCM, the LCM procedure is for the case that a given functionality is provided by some sensing operations. In the sensing type-based LCM, the LCM procedure is for the case that a sensing type (e.g., a sensing model) which has a type ID (e.g., model ID) with associated information is provided by some sensing operations.

In some embodiments, the sensing may be performed at the UE side. To avoid sensing failure, the sensing functionality supported by the UE needs to be identified. For example, the UE may report its supported functionalities/functionality for a given sensing feature (i.e., sensing use case), e.g. by UE capability report. Examples of the sensing use cases may include but not limited to environment reconstruction, channel prediction, intruder detection, pedestrian/animal intrusion detection, rainfall monitoring, transparent sensing, sensing for flooding, intruder detection in surroundings of smart home, sensing for railway intrusion detection, sensing assisted automotive maneuvering and navigation, automated guided vehicle (AGV) detection and tracking in factories, unmanned aerial vehicle (UAV) flight trajectory tracing, sensing at crossroads with/without obstacle, network assisted sensing to avoid UAV collision, sensing for UAV intrusion detection, sensing for tourist spot traffic management, contactless sleep monitoring service, protection of sensing information, health monitoring, service continuity of unobtrusive health monitoring, use case on sensor groups, sensing for parking space determination, seamless extended reality (XR) streaming, UAVs/vehicles/pedestrians detection near smart grid equipment, autonomous mobile robots collision avoidance in smart factories, roaming for sensing service of sports monitoring, on immersive experience based on sensing, accurate sensing for automotive maneuvering and navigation service, public safety search and rescue or apprehend, vehicles sensing for advanced driving assistance system, gesture recognition for application navigation and immersive interaction, sensing for automotive maneuvering and navigation service when not served by RAN, blind spot detection, integrated sensing and positioning in factory hall.

A sensing feature may be associated to an index. In some embodiments, the UE may report an index of its supported feature index, and index(es) of its supported functionalities/functionality in the feature. Examples of indexes are given in Table 1 for sensing features and associated sensing functionalities in the sensing features. One or multiple sensing functionalities are defined within a sensing-enabled feature (i.e., a sensing feature). For example, three sensing functionalities are associated to the sensing feature of environment reconstruction with feature index #1, i.e. imaging functionality (with functionality index #1-1), localization functionality (with functionality index #1-2), channel mapping functionality (with functionality index #1-3). Two sensing functionalities are associated to the sensing feature of channel prediction with feature index #2, i.e. angle prediction by ray tracing on the environment map (with functionality index #2-1), power prediction by ray tracing on the environment map (with functionality index #2-2).

TABLE 1
Examples of sensing features and associated sensing functionalities

| Features | Index | Feature group |
|---|---|---|
| 1. Environment | 1-1 | imaging functionality |
| Reconstruction | 1-2 | localization functionality |
| | 1-3 | Channel mapping functionality |
| 2. Channel | 2-1 | Angle prediction by ray tracing |
| prediction | | on the environment map |
| | 2-2 | Power prediction by ray tracing |
| | | on the environment map |

The status of a functionality may include configured, active, and inactive. For example, a UE may report its supported functionality(ies) to the BS. In a more specific example, the UE may report an index #1 of its supported sensing feature and indexes #1-1, #1-2, #1-3 of supported functionalities within the supported feature. It should be noted that the functionality indexes #1-1, #1-2, #1-3 are merely for illustration, other functionality indexes are also possible. For example, functionality indexes may be #1, #2, #3 and the BS may configure the functionality within the sensing feature, i.e. a functionality is associated to a sensing feature.

According to the UE capability, the BS may transmit configurations of one or multiple functionalities which are supported by the UE for a sensing feature to the UE. Accordingly, the UE may be configured with one or multiple functionalities for a sensing feature, which may be a subset or all of the supported functionalities within the supported feature. In some embodiments, after configuration, the configured functionalities are inactive by default. Alternatively, at least one functionality for a sensing feature may be active by default.

In some embodiments, the BS may transmit a signaling to activate or de-activate at least one functionality among the configured/identified functionality(ies) of the UE. The configured/identified functionality may be activated based on an activation request of the functionality from the BS. The active sensing functionality(ies) may be a subset or all of the identified or configured functionalities. In some embodiments, due to change of memory, battery, and other hardware, the applicable functionality(ies) of the UE may be changed accordingly. The UE may transmit assistance information to report its updated applicable functionality(ies), then the BS may activate the applicable functionalities accordingly.

In a specific example, a sensing feature with feature index 1 and sensing functionalities with functionality indexes 1-1, 1-2, 1-3 within the sensing feature may be configured to the UE. The BS may transmit an activation signaling comprising functionality indexes 1-1, 1-2 so as to indicate the UE to activate functionality indexes with functionality indexes 1-1, 1-2. In some examples, before receiving the activation signaling, the UE may report applicable functionalities with functionality indexes 1-1, 1-2 to the BS. The BS may transmit the activation signaling to indicate the UE to activate the applicable functionalities with functionality indexes 1-1, 1-2.

For a sensing feature, a UE may have one or multiple sensing types (e.g., sensing models), e.g. scenario/configuration/sensing method specific (including site-specific configuration/channel conditions) types. For example, a UE may be configured with one or multiple sensing types (e.g., sensing models) for a sensing feature. Each sensing type may be associated with an ID. The type ID (e.g., the model ID) is to aligning the common understanding between the BS and the UE on the sensing type (e.g., sensing model) and/or sensing functionalities.

In a first specific example, for the sensing feature of channel prediction, a sensing type/model is associated to an environment map (e.g., a site-specific map). When the UE moves to another location, different sensing type/model which is associated to another environment map (i.e., another site-specific map) may be used.

In a second specific example, for the sensing feature of environment reconstruction, a first sensing type/model is for a static environment reconstruction, a second sensing type/model is for reconstruction of a static environment with moving targets (with low speed), and a third sensing model is for a rainy environment reconstruction.

In a third specific example, for the sensing feature of object detection, a first sensing type is for mono-static sensing, a second sensing type is for bi-static sensing where the UE is the sensing transmitter, and a third sensing type is for bi-static sensing where the UE is the sensing receiver.

In some embodiments, one or multiple functionalities may be associated with the same sensing type (e.g., a sensing model) for a sensing feature. Same or different functionalities may be associated with different sensing types. In a specific example, for the sensing feature of object detection, the first sensing type is mono-static sensing by RF signalling. A functionality #0 for the first sensing type is object existence detection, a functionality #1 for the first sensing type is range detection, and a functionality #2 for the first sensing type is speed detection. The second sensing type is combined mono-static sensing by RF signalling and non-RF sensing (e.g. camera). A functionality #0 for the second sensing type is object existence detection, a functionality #1 for the second sensing type is range detection, a functionality #2 for the second sensing type is speed detection, and a functionality #3 for the second sensing type is shape detection.

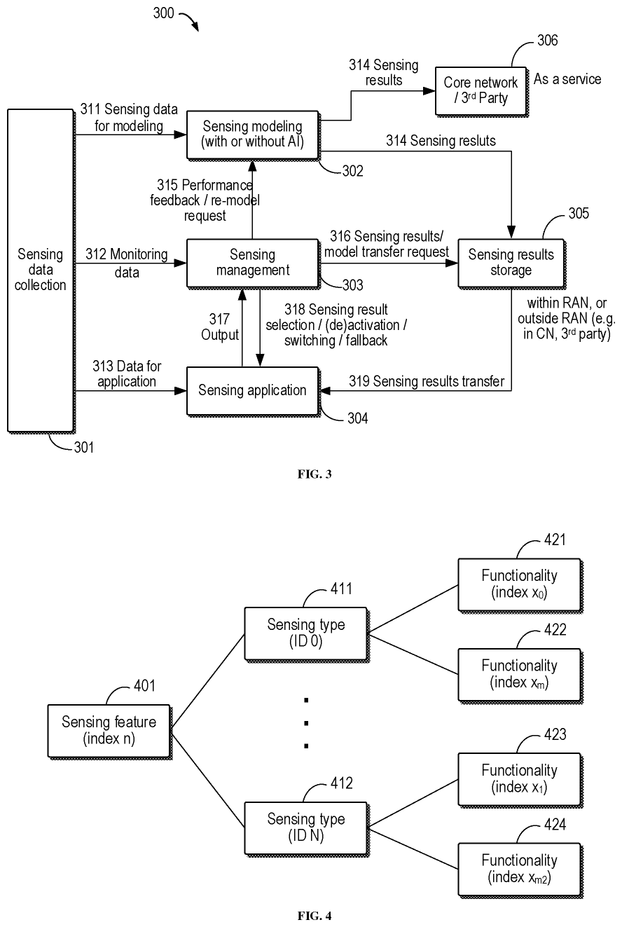

FIG. 4 illustrates a schematic diagram of an example sensing feature in accordance with some embodiments of the present disclosure. As shown in FIG. 4, the sensing feature 401 is configured with an index n. In the sensing feature 401, there are one or multiple sensing types (e.g., sensing models). A sensing type is configured with an ID. For example, the sensing type 411 may be configured with a sensing type ID 0, and the sensing type 412 may be configured with a sensing type ID N. In some embodiments, the sensing type ID may be locally unique within the sensing feature. In other words, the same sensing type ID may be allocated to two sensing types within different sensing features. The BS needs to transmit both the index of the sensing feature and the ID of the sensing type in the sensing feature to the UE when indicating a specific sensing type. Alternatively, the sensing type ID may be globally unique for all the configured sensing features for the UE. In this way, by indicating the sensing type ID, the UE knows the sensing feature associated with the sensing type. One or multiple sensing functionalities may be associated with a sensing type. Each sensing functionality may be configured with a functionality index. For example, the functionality 421 with index x0 and the functionality 422 with index xm may be associated with the sensing type 411. The functionality 423 with index x1 and the functionality 424 with index xm2 may be associated with the sensing type 412.

In this way, methods related to sensing identification between the BS and the UE, including sensing functionality identification, sensing type identification, as well as configured functionality identification and active sensing functionality identification, are defined.

Turning back to FIG. 3, in some embodiments, in the sensing functional framework 300, the BS may configure at least one sensing feature and one or more sensing functionalities within each sensing feature to the UE. In a sensing functionality-based LCM, the network may activate one or multiple sensing features and corresponding sensing type. In a sensing type-based LCM, the network may activate one or multiple sensing features and corresponding sensing functionalities. The UE may determine the sensing model for the sensing procedure based on the activated sensing feature and sensing functionalities. Then, the UE may perform a sensing procedure according to the configuration from the BS. The format and/or content of the UE sensing report data may be associated to the activated sensing functionalities.

In some embodiments, the sensing features, and/or sensing types (e.g., sensing models), and/or sensing functionalities may be changed during the sensing period. In a first specific example, the BS may transmit an indication of switching of a sensing functionality for a same sensing feature to the UE. For example, a UE may only support one sensing functionality at a time slot. The UE may be indicated to switch from a current sensing functionality to another sensing functionality for a same sensing feature. By performing different sensing functionalities in different time slots, the UE can support the whole sensing feature. In a second specific example, the BS may transmit an indication of activating multiple sensing functionalities for a sensing feature to the UE. For example, for a UE with high capability, multiple active sensing functionalities can reduce sensing latency. In a third specific example, the BS may transmit an indication of switching of a sensing feature to the UE. For example, the UE is currently performing a sensing feature of environment reconstruction. After the static environment reconstruction is finished, the BS may indicate the UE to switch to moving object detection to get the moving target information in the static environment. In a fourth specific embodiment, the BS may transmit an indication of switching of sensing type (sensing model) for a sensing feature to the UE. For example, for a sensing feature of object detection, a first sensing type is for mono-static sensing, a second sensing type is for bi-static sensing where the UE is the sensing transmitter, and a third sensing type is for bi-static sensing where the UE is the sensing receiver. The BS may indicate the UE to switch from the second sensing type to the third sensing type according to the sensing frame structure.

In some embodiments, one or multiple sensing features may be activated/deactivated for the UE. For example, the BS may activate one or multiple sensing features among the configured sensing features, or among the sensing features supported by the UE (e.g., identified based on the UE capability report). Only one active sensing type may be supported for a sensing feature. The BS may transmit a high layer signaling or a DCI to the UE to indicate a type activation or a type switching. For example, the DCI for activating a sensing type or for switching to a sensing type may be implemented as {feature index, active sensing type ID} or {feature index, active model ID}. In some embodiment, a sensing type may be active by default when a sensing feature is enabled. In other words, there may be a default active sensing type ID when the sensing feature is enabled for the UE. The default active sensing type ID may be predefined, e.g. type ID 0 may be predefined as the default active sensing type. Alternatively, the default active sensing type ID may be configured by the BS.

In some embodiments, one or multiple active sensing functionalities for a same sensing type may be supported by the UE. The BS may transmit an indication of activating/deactivating one or multiple sensing functionalities to the UE. In some implementations, the activation/de-activation may be type-specific. For example, different sensing types associated to the same sensing feature may have different active sensing functionality(ies). The BS may transmit an indication implemented as {feature index, active sensing type ID, active sensing functionality(ies)} to the UE to indicate the sensing functionality(ies) to be activated. Alternatively, the activation/de-activation may be feature-specific. For example, different sensing types associated to the same sensing feature may have the same active sensing functionality(ies). The BS may transmit an indication implemented as {feature index, active sensing functionality(ies)} to the UE to indicate the sensing functionality(ies) to be activated.

In some embodiment, a sensing functionality may be active by default when a sensing feature/type is enabled. In other words, there may be a default active sensing functionality ID when the sensing feature/type is enabled for the UE. The default active sensing functionality ID may be predefined, e.g. functionality ID 0 may be predefined as the default active sensing functionality. Alternatively, the default active sensing functionality ID may be configured by the BS. The format and/or content of the UE sensing report data may be associated to the active sensing feature and active sensing functionality.

In some embodiments, the sensing management function 303 may be responsible for performing sensing control to the sensing modelling function 302 and the sensing application function 304, and may monitor the sensing output of the sensing application function 304. If the sensing results are no longer applicable, the sensing management function 303 may request the sensing modelling function 302 to re-train the sensing model, and may indicate the sensing application function 304 to switch the sensing model.

The sensing type monitoring may be implemented at UE side or at BS side. In a first implementation, the sensing type monitoring may be implemented at BS side. For example, the BS may transmit an indication of switching a sensing type or disabling a sensing functionality to a UE.

In a second implementation, the sensing type monitoring may be implemented at UE side. For example, the UE may transmit a type switch request (including fallback to a non-sensing mode) and sensing performance to the BS. According to the report from the UE, the BS may indicate the UE to switch to another sensing model/sensing type, or indicate the UE to disable sensing. Optionally, the BS may transmit a monitoring metric to the UE. Alternatively or additionally, the BS may transmit a reporting metric to the UE. The UE may evaluate the performance of the sensing type. When the UE determines that the sensing type is not applicable based on the monitoring metric and/or reporting metric, the UE may transmit a type switch request (including fallback to non-sensing mode) and sensing performance to the BS. In a first specific example, if the active sensing feature is channel prediction and the active sensing type is a static environment map, when the UE sensed that there are multiple surrounding moving targets, the UE may transmit a type switch request or a request to fallback to non-sensing mode to the BS. In a second specific example, if the active sensing feature is channel prediction and the active sensing type is a site-specific environment map, when the UE moves to another site (or the cell edge of the site), the UE may transmit a type switch request to the BS. According to UE's report, the BS may indicate the UE to switch to another sensing model/sensing type, or to indicate the UE to disable sensing.

In some embodiments, the sensing parameters may be flexibly updated as the scenario/configuration/site that the UE experiences changes over time. For example, the UE may transmit a sensing model update request to the BS based on the changed scenario/configuration/site. The BS may transmit training data and associated ground-truth information to the UE to assist the UE to update the sensing model. The BS may transmit assistance information to assist the UE to fine-tune the sensing model. For example, the BS may transmit an anchor information (e.g., information of a target object at a known location) to the UE, and the UE may calibrate the sensing results based on the assistance information.

In this way, methods related to sensing management, including sensing activation, sensing monitoring and sensing update, are defined.

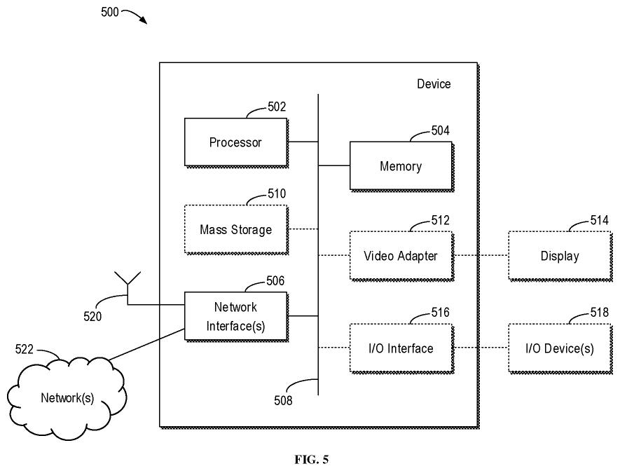

FIG. 5 is a block diagram of a device 500 that may be used for implementing some embodiments of the present disclosure. In some embodiments, the device 500 may be an element of communications network infrastructure, such as a base station (for example, a NodeB, an evolved Node B (eNodeB, or eNB), a next generation NodeB (sometimes referred to as a gNodeB or gNB), a home subscriber server (HSS), a gateway (GW) such as a packet gateway (PGW) or a serving gateway (SGW) or various other nodes or functions within a core network (CN) or a Public Land Mobility Network (PLMN). In other embodiments, the device 500 may be a device that connects to the network infrastructure over a radio interface, such as a mobile phone, smart phone or other such device that may be classified as a User Equipment (UE). In some embodiments, the device 500 may be a Machine Type Communications (MTC) device (also referred to as a machine-to-machine (M2M) device), or another such device that may be categorized as a UE despite not providing a direct service to a user. In some embodiments, the device 500 may be a road side unit (RSU), a vehicle UE (V-UE), pedestrian UE (P-UE) or an infrastructure UE (I-UE). In some scenarios, the device 500 may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, the device 500 may contain multiple instances of a component, such as multiple processors, memories, transmitters, receivers, etc.

The device 500 typically includes a processor 502, such as a Central Processing Unit (CPU), and may further include specialized processors such as a Graphics Processing Unit (GPU) or other such processor, a memory 504, a network interface 506 and a bus 508 to connect the components of the device 500. The device 500 may optionally also include components such as a mass storage device 510, a video adapter 512, and an I/O interface 516 (shown in dashed lines).

The memory 504 may comprise any type of non-transitory system memory, readable by the processor 502, such as static random access memory (SRAM), dynamic random access memory (DRAM), synchronous DRAM (SDRAM), read-only memory (ROM), or a combination thereof. In an embodiment, the memory 504 may include more than one type of memory, such as ROM for use at boot-up, and DRAM for program and data storage for use while executing programs. The bus 508 may be one or more of any type of several bus architectures including a memory bus or memory controller, a peripheral bus, or a video bus.

The device 500 may also include one or more network interfaces 506, which may include at least one of a wired network interface and a wireless network interface. As illustrated in FIG. 5, network interface 506 may include a wired network interface to connect to a network 522, and also may include a radio access network interface 520 for connecting to other devices over a radio link. When the device 500 is a network infrastructure element, the radio access network interface 520 may be omitted for nodes or functions acting as elements of the PLMN other than those at the radio edge (e.g., an eNB). When the device 500 is infrastructure at the radio edge of a network, both wired and wireless network interfaces may be included. When the device 500 is a wirelessly connected device, such as a User Equipment, radio access network interface 520 may be present and it may be supplemented by other wireless interfaces such as WiFi network interfaces. The network interfaces 506 allow the device 500 to communicate with remote entities such as those connected to network 522.

The mass storage 510 may comprise any type of non-transitory storage device configured to store data, programs, and other information and to make the data, programs, and other information accessible via the bus 508. The mass storage 510 may comprise, for example, one or more of a solid state drive, hard disk drive, a magnetic disk drive, or an optical disk drive. In some embodiments, the mass storage 510 may be remote to the device 500 and accessible through use of a network interface such as interface 506. In the illustrated embodiment, the mass storage 510 is distinct from memory 504 where it is included, and may generally perform storage tasks compatible with higher latency, but may generally provide lesser or no volatility. In some embodiments, the mass storage 510 may be integrated with a heterogeneous memory 504.

The optional video adapter 512 and the I/O interface 516 (shown in dashed lines) provide interfaces to couple the device 500 to external input and output devices. Examples of input and output devices include a display 514 coupled to the video adapter 512 and an I/O device 518 such as a touch-screen coupled to the I/O interface 516. Other devices may be coupled to the device 500, and additional or fewer interfaces may be utilized. For example, a serial interface such as Universal Serial Bus (USB) (not shown) may be used to provide an interface for an external device. Those skilled in the art will appreciate that in embodiments in which the device 500 is part of a data center, I/O interface 516 and Video Adapter 512 may be virtualized and provided through network interface 506.

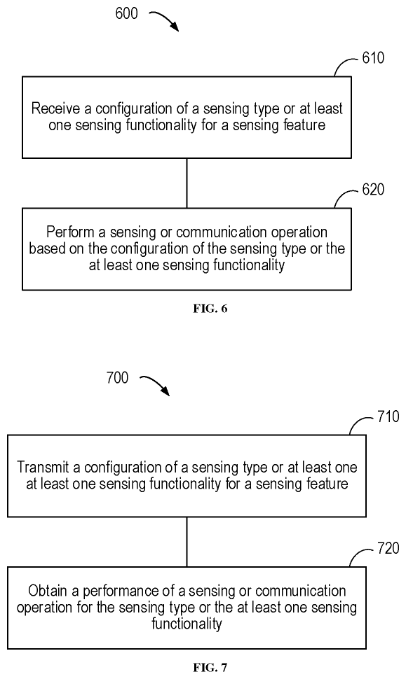

FIG. 6 illustrates an example of a method implemented at a terminal device in which some example embodiments of the present disclosure may be implemented. In some embodiments, the method 600 can be implemented at a device in a communication network, such as the terminal device 2010 as shown in FIG. 2. Additionally or alternatively, the method 600 can be implemented at other devices. Further, it is to be understood that the method 600 may include additional blocks not shown and/or may omit some blocks as shown, and the scope of the present disclosure is not limited in this regard. For the purpose of discussion, the method 600 will be described from the perspective of the terminal device 2010 with reference to FIG. 2.

In the method 600, at 610, the terminal device receives a configuration of a sensing type or at least one sensing functionality for a sensing feature. At 620, the terminal device performs a sensing or communication operation based on the configuration of the sensing type or the at least one sensing functionality.

FIG. 7 illustrates an example of a method implemented at a network device in which some example embodiments of the present disclosure may be implemented. In some embodiments, the method 700 can be implemented at a device in a communication network, such as the network device 2070 as shown in FIG. 2. Additionally or alternatively, the method 700 can be implemented at other devices. Further, it is to be understood that the method 700 may include additional blocks not shown and/or may omit some blocks as shown, and the scope of the present disclosure is not limited in this regard. For the purpose of discussion, the method 700 will be described from the perspective of the network device 2070 with reference to FIG. 2.

In the method 700, at 710, the network device transmits a configuration of a sensing type or at least one at least one sensing functionality for a sensing feature. At 720, the network device obtains a performance of a sensing or communication operation for the sensing type or the at least one sensing functionality.

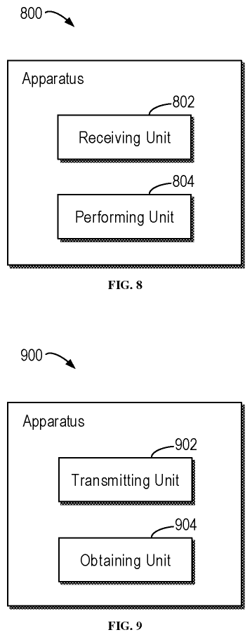

FIG. 8 is a schematic diagram of a structure of an apparatus 800 in accordance with some embodiments of the present disclosure. As shown in FIG. 8, the apparatus 800 includes a receiving unit 802 and a performing unit 804. The apparatus 800 may be applied to the communication system as shown in FIG. 1, and may implement any of the methods provided in the foregoing embodiments. Optionally, a physical representation form of the apparatus 800 may be a communication device, for example, a UE. Alternatively, the apparatus 800 may be another apparatus that can implement a function of a communication device, for example, a processor or a chip inside the communication device. Specifically, the apparatus 800 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the receiving unit 802 may be configured to receive a configuration of a sensing type or at least one sensing functionality for a sensing feature. The performing unit 804 may be configured to perform a sensing or communication operation based on the configuration of the sensing type or the at least one sensing functionality.

In some other embodiments, the apparatus 800 can include various other units or modules which may be configured to perform various operations or functions as described in connection with the foregoing method embodiments. The details can be obtained referring to the detailed description of the foregoing method embodiments and are not described herein again.

It should be noted that division into the units or modules in the foregoing embodiments of the present disclosure is an example, and is merely logical function division. In actual implementation, there may be another division manner. In addition, function units in embodiments of the present disclosure may be integrated into one processing unit, or may exist alone physically, or two or more units may be integrated into one unit. The integrated unit may be implemented in a form of hardware, or may be implemented in a form of a software function unit.

When the integrated unit is implemented in a form of a software function unit and sold or used as an independent product, the integrated unit may be stored in a computer-readable storage medium. Based on such an understanding, the technical solutions of the present disclosure essentially, or all or some of the technical solutions may be implemented in a form of a software product. The computer software product is stored in a storage medium and includes several instructions for instructing a computer device (which may be a personal computer, a server, or a network device) or a processor (processor) to perform all or some of the steps of the methods described in embodiments of the present disclosure. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

FIG. 9 is a schematic diagram of a structure of an apparatus 900 in accordance with some embodiments of the present disclosure. As shown in FIG. 9, the apparatus 900 includes a transmitting unit 902 and a obtaining unit 904. The apparatus 900 may be applied to the communication system as shown in FIG. 1, and may implement any of the methods provided in the foregoing embodiments. Optionally, a physical representation form of the apparatus 900 may be a communication device, for example, a network device. Alternatively, the apparatus 900 may be another apparatus that can implement a function of a communication device, for example, a processor or a chip inside the communication device. Specifically, the apparatus 900 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some embodiments, the transmitting unit 902 may be configured to transmit a configuration of a sensing type or at least one at least one sensing functionality for a sensing feature. The obtaining unit 904 may be configured to obtain a performance of a sensing or communication operation for the sensing type or the at least one sensing functionality.

In some other embodiments, the apparatus 900 can include various other units or modules which may be configured to perform various operations or functions as described in connection with the foregoing method embodiments. The details can be obtained referring to the detailed description of the foregoing method embodiments and are not described herein again.

It should be noted that division into the units or modules in the foregoing embodiments of the present disclosure is an example, and is merely logical function division. In actual implementation, there may be another division manner. In addition, function units in embodiments of the present disclosure may be integrated into one processing unit, or may exist alone physically, or two or more units may be integrated into one unit. The integrated unit may be implemented in a form of hardware, or may be implemented in a form of a software function unit.

When the integrated unit is implemented in a form of a software function unit and sold or used as an independent product, the integrated unit may be stored in a computer-readable storage medium. Based on such an understanding, the technical solutions of the present disclosure essentially, or all or some of the technical solutions may be implemented in a form of a software product. The computer software product is stored in a storage medium and includes several instructions for instructing a computer device (which may be a personal computer, a server, or a network device) or a processor (processor) to perform all or some of the steps of the methods described in embodiments of the present disclosure. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

Based on the foregoing embodiments, an embodiment of this application further provides a computer program. When the computer program is run on a computer, the computer is enabled to perform any of the methods provided in the foregoing embodiments.

Based on the foregoing embodiments, an embodiment of this application further provides a computer-readable storage medium. The computer-readable storage medium stores a computer program. When the computer program is executed by a computer, the computer is enabled to perform the any of the methods provided in the foregoing embodiments. The storage medium may be any usable medium that can be accessed by a computer. By way of example and not limitation, the computer-readable medium may include a RAM, a ROM, an EEPROM, a CD-ROM or another optical disk storage, a magnetic disk storage medium or another magnetic storage device, or any other medium that can be used to carry or store expected program code in a form of an instruction or a data structure and that can be accessed by a computer.

Based on the foregoing embodiments, an embodiment of the present disclosure further provides a chip. The chip is configured to read a computer program stored in a memory, to implement any of the methods provided in the foregoing embodiments.

Based on the foregoing embodiments, an embodiment of the present disclosure provides a chip system. The chip system includes a processor, configured to support a computer apparatus in implementing functions related to communication devices in the foregoing embodiments. In a possible design, the chip system further includes a memory, and the memory is configured to store a program and data that are necessary for the computer apparatus. The chip system may include a chip, or may include a chip and another discrete component.

A person skilled in the art should understand that embodiments of the present disclosure may be provided as a method, a system, or a computer program product. Therefore, the present disclosure may be in a form of a hardware-only embodiment, a software-only embodiment, or an embodiment combining software and hardware aspects. In addition, the present disclosure may be in a form of a computer program product implemented on one or more computer-usable storage media (including but not limited to a magnetic disk memory, a CD-ROM, an optical memory, and the like) including computer-usable program code.

The present disclosure is described with reference to the flowcharts and/or block diagrams of the method, the device (system), and the computer program product according to the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more processes in the flowcharts and/or in one or more blocks in the block diagrams.

It is clear that a person skilled in the art may make various modifications and variations to the present disclosure without departing from the protection scope of the present disclosure. Thus, the present disclosure is intended to cover these modifications and variations, provided that they fall within the scope of the claims of the present disclosure and their equivalent technologies.

What is claimed is:

1. A method comprising:
receiving, by a terminal device, a configuration of a sensing type or at least one sensing functionality for a sensing feature; and
performing a sensing operation or a communication operation based on the configuration of the sensing type or the at least one sensing functionality.

2. The method of claim 1, further comprising:
transmitting an indication of the sensing feature and an indication of one or more sensing functionalities associated with the sensing feature, wherein the sensing feature and the one or more functionalities are supported by the terminal device; and
receiving a configuration of a subset of the one or more sensing functionalities for the sensing feature, wherein the subset of the one or more sensing functionalities comprise the at least one sensing functionality.

3. The method of claim 1, wherein the sensing type is identified based on an index, wherein the index is unique in at least one sensing type for one or more sensing features.

4. The method of claim 1, wherein performing the sensing operation or the communication operation comprises:
activating the sensing type; and
upon determining that the sensing type is activated, performing the sensing operation or the communication operation.

5. A method comprising:
transmitting, by a network device, a configuration of a sensing type or at least one sensing functionality for a sensing feature; and
obtaining a performance of a sensing operation or a communication operation for the sensing type or the at least one sensing functionality.

6. The method of claim 5, further comprising:
receiving an indication of the sensing feature and an indication of one or more sensing functionalities associated with the sensing feature, wherein the sensing feature and the one or more functionalities are supported by a terminal device; and
transmitting a configuration of a subset of the one or more sensing functionalities for the sensing feature, wherein the subset of the one or more sensing functionalities comprise the at least one sensing functionality.

7. The method of claim 5, further comprising:
receiving assistance information associated with a sensing capability of a terminal device, wherein the assistance information comprises at least one updated applicable functionality of the terminal device.

8. The method of claim 5, wherein the sensing type is identified based on an index, wherein the index is unique in at least one sensing type for one or more sensing features.

9. An apparatus comprising:
at least one processor coupled with a non-transitory computer readable memory storing instructions, wherein when the at least one processor executes the instructions, the apparatus is caused to:
receive a configuration of a sensing type or at least one sensing functionality for a sensing feature; and
perform a sensing operation or communication operation based on the configuration of the sensing type or the at least one sensing functionality.

10. The apparatus of claim 9, wherein the apparatus is further caused to:
transmit an indication of the sensing feature and an indication of one or more sensing functionalities associated with the sensing feature, wherein the sensing feature and the one or more functionalities are supported by the apparatus; and
receive a configuration of a subset of the one or more sensing functionalities for the sensing feature, wherein the subset of the one or more sensing functionalities comprise the at least one sensing functionality.

11. The apparatus of claim 9, wherein the sensing type is identified based on an index, wherein the index is unique in at least one sensing type for one or more sensing features.

12. The apparatus of claim 9, wherein performing the sensing operation or the communication operation comprises:
activating the sensing type; and
upon determining that the sensing type is activated, performing the sensing operation or the communication operation.

13. The apparatus of claim 9, wherein the apparatus is further caused to:
receive an indication of activating the at least one functionality,
wherein:
the indication of activating the at least one functionality is associated with the sensing type, or
the indication of activating the at least one functionality is associated with the sensing feature.

14. The apparatus of claim 9, wherein the apparatus is further caused to:
transmit a request for updating the sensing type;
after transmitting the request, receive training data and ground-truth information for the sensing type; and
update the sensing type based on the training data and the ground-truth information.

15. A apparatus comprising:
at least one processor coupled with a non-transitory computer readable memory storing instructions, wherein when the at least one processor executes the instructions, the apparatus is caused to:
transmit a configuration of a sensing type or at least one sensing functionality for a sensing feature; and
obtain a performance of a sensing or communication operation for the sensing type or the at least one sensing functionality.

16. The apparatus of claim 15, wherein the apparatus is further caused to:
receive an indication of the sensing feature and an indication of one or more sensing functionalities associated with the sensing feature, wherein the sensing feature and the one or more functionalities are supported by a terminal device; and
transmit a configuration of a subset of the one or more sensing functionalities for the sensing feature, wherein the subset of the one or more sensing functionalities comprise the at least one sensing functionality.

17. The apparatus of claim 15, wherein the apparatus is further caused to:
receive assistance information associated with a sensing capability of a terminal device, wherein the assistance information comprises at least one updated applicable functionality of the terminal device.

18. The apparatus of claim 15, wherein the sensing type is identified based on an index, wherein the index is unique in at least one sensing type for one or more sensing features.

19. The apparatus of claim 15, wherein the apparatus is further caused to:
transmit an indication of activating the at least one functionality,
wherein:
the indication of activating the at least one functionality is associated with the sensing type, or
the indication of activating the at least one functionality is associated with the sensing feature.

20. The apparatus of claim 15, wherein the apparatus is further caused to:
transmit an indication of activating the at least one functionality,
wherein:
the indication of activating the at least one functionality is associated with the sensing type, or
the indication of activating the at least one functionality is associated with the sensing feature.
